(19) United States
(12) Patent Application Publication
(10) Pub. No.: US 2017/0018289 A1
(43) Pub. Date: Jan. 19, 2017

(54) EMOJI AS FACETRACKING VIDEO MASKS

(71) Applicant: String Theory, Inc., Los Angeles, CA (US)

(72) Inventor: Jared S. Morgenstern, Los Angeles, CA (US)

(21) Appl. No.: 15/211,928

(22) Filed: Jul. 15, 2016

Related U.S. Application Data
(60) Provisional application No. 62/192,710, filed on Jul. 15, 2015.

(51) Int. Cl. G11B 27/036; G06K 9/00; G06F 3/0482; H04N 5/77; G11B 27/34; G06F 3/0481

(52) U.S. Cl. CPC G11B 27/036; G11B 27/34; G06F 3/04817; G06F 3/0482; H04N 5/772; G06K 9/00315

(57) ABSTRACT

The system disclosed herein allows a user to select and/or create a mask using emoji or other expressions and to add the selected mask to track a face or other elements of a video. By utilizing the existing emoji character set, users are familiar with the expressiveness of the masks they can create and can quickly find them. By combining emoji with face tracking software the system provides a more intuitive and fun interface for making playful and expressive videos.

### CROSS-REFERENCE TO RELATED APPLICATIONS

The present application claims benefit of priority to U.S. Provisional Patent Application No. 62/192,710, entitled “Emoji as Facetracking Video Masks” and filed on Jul. 15, 2015, which is specifically incorporated by reference for all that it discloses and teaches.

### FIELD

Implementations disclosed herein relate, in general, to information management technology and specifically to video recording.

### SUMMARY

The video stickering system disclosed herein, referred to as Emoji Masks System, provides for a method of enabling a user to add an animated or still image overlay on a video. For example, when a user is watching or is creating a video, an emoji mask can be overlaid on the video by simply selecting an emoji or other character from a keyboard. In one implementation, upon selection by the user, the emoji or such other character gets enlarged or is interpreted and enlarged as a related symbol and then can be added on top of the video. Yet alternatively, if the emoji mask system recognizes a face or a designated feature in the video, the emoji is added on top of such recognized face and tracks the recognized face. In one alternative implementation, the system allows a user to manually adjust the tracking position of the emoji mask.

Many people are familiar with expressing themselves through various emoji that have become new symbols of international language. The emoji mask system disclosed herein allows users to choose an emoji and then enlarge said emoji into a mask. As a result, the emoji mask system extends the expressiveness and makes it more convenient for a user to express themselves through the use of a related emoji.

In one implementation, upon selection of an emoji, or such other expression, the emoji is enlarged to cover faces as they move in the video. In another, an emoji, for example a heart emoji, could be associated with an animation, such as animated hearts—that appear above the head of the user moving in the video. Thus, the system allows an emoji to be used directly, and/or associated with a paired image or animation and a face offset that tells it where to display the mask.

In one implementation, the emoji masks can be selected before recording. In another, during recording and even swappable during recording, and, in another, in a review or playback step. One implementation allows all three methods of mask selection.

In one implementation, masks are chosen by sliding a tray showing the masks that appear when you toggle on the mask interface and when you swipe to the right, a keyboard comes up, letting you preview different emoji.

In another implementation, the system can keep track of your last used emoji and use them to populate the sliding tray.

In another implementation, multiple faces—if found in the video—can be mapped to various slots in the tray. In this implementation, hot swapping the masks during recording could cycle them from person to person in a group video.

In another implementation, a user can create his or her own emoji, by selecting a drawing icon in the tray that lets the user draw his or her own mask.

In another implementation, the system can use signals such as a user's location current time and change an emoji symbol based on the such location and time. For example, if the user was located to be in San Francisco and if the system determines that the San Francisco Giants are playing in the World Series at the time of selection of a hat emoji, the emoji mask system disclosed herein automatically changes or interprets the hat emoji with a Giants image to make it a Giants hat emoji. Alternatively, it also allows users to add their own text, image, etc., on top of such hat emoji before the hat emoji is attached to and tracks a face in the video.

In another implementation, the video content itself may be used to help determine how to display the mask. For example, a winking person may make the mask wink. A smiling person may make it frown. Someone shaking their head rapidly may make a head shake animation. Someone jumping may make lift off smoke appear.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example flow chart for providing emoji masks based on an implementation of an emoji mask system disclosed herein.

FIG. 2 illustrates various examples of emoji masks tracking a user face in a video.

FIG. 3 illustrates an example interface for selecting an emoji mask for tracking user faces in a video.

FIG. 4 illustrates an example interface for selecting an emoji mask from an emoji keyboard for tracking user faces in a video.

FIG. 5 illustrates an example interface for applying an animated emoji for tracking user faces in a video.

FIG. 6 illustrates an example flow chart for displaying an emoji mask on a user face in a video.

FIG. 7 illustrates an example system that may be useful in implementing the described technology.

FIG. 8 illustrates an example system including various components of the described technology.

### DETAILED DESCRIPTION

The recording system disclosed herein, referred to as emoji masks system, provides for a method of enabling a user recording a video to a mask tracking his or her face using an emoji or other similar expression graphics such that the emoji, or such other expression graphics, tracks the movement of the user's face in the video.

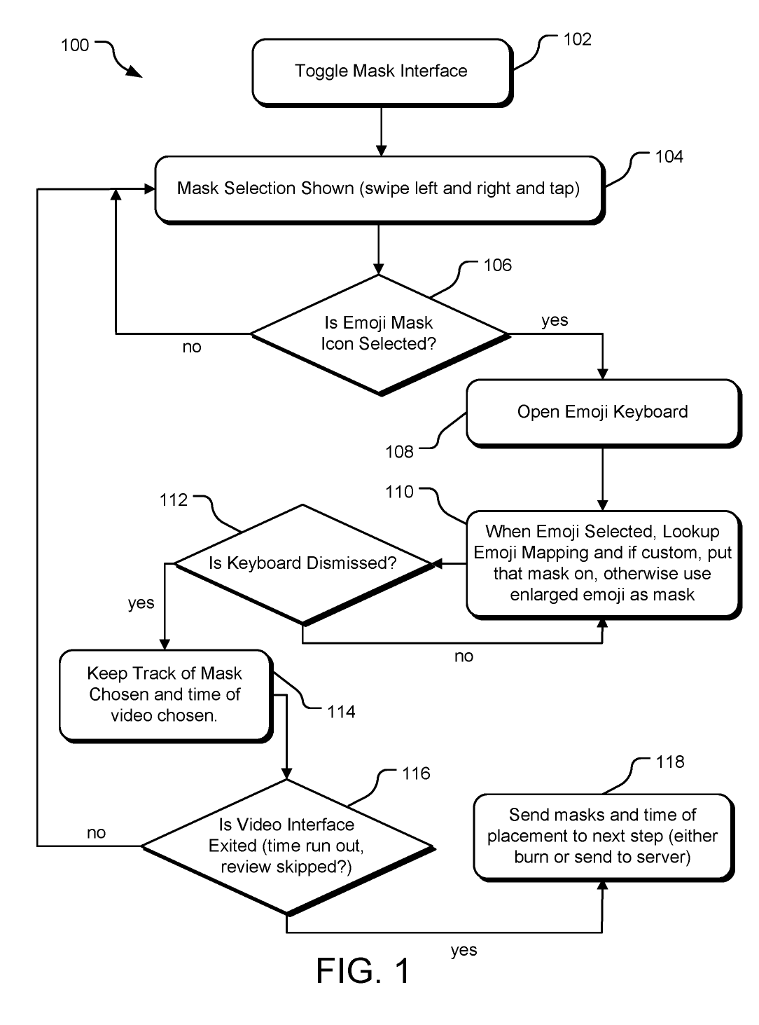

FIG. 1 illustrates a flow chart 100 depicting an implementation of emoji mask system that details the process for selection, replacement, and interfacing with video tracking. An operation 102 presents a toggle mask interface. The toggle mask interface may be presented before a recording of a video, during the recording of the video, or after the recording in complete. For example, during an editing phase of the video, the user may invoke the toggle mask interface in a manner disclosed herein. Alternatively, the user may also invoke the toggle mask interface during a playback phase of the video.

When the user has selected the toggle mask interface, a mask tray appears at the bottom of the video screen. At operation 104, mask selection is shown. A user may cycle through a selection of masks and select a mask from the mask tray within the toggle mask interface. An operation 106 determines if an emoji mask icon is selected. If an emoji mask is selected, an operation 108 opens an emoji keyboard. Subsequently, an operation 110 looks up emoji mapping and if it determines custom mapping, the mask is added to the video. Otherwise, the emoji can be enlarged to generate an enlarged mask that is used as a mask on a face. The system recognizes a face or a designated feature in the video, and the emoji is overlaid on the face or designated feature and tracks it.

The emoji mapping may include mapping of emojis from the emoji keyboard or from the emoji tray to animations to be added on top of the video. For example, if an emoji for a light bulb may be mapped to a blinking light bulb, a static light bulb, etc. Similarly, an emoji for a heart may be mapped to an animated heart, an emoji for sun may be mapped to weather, a shining sun, etc. In one implementation, when a user selects an emoji, a new interface listing various possible mappings for that emoji are displayed to a user and the user can select a mapping therefrom. Thus, in effect, this listing of various possible mapping provides a second keyboard or tray of emojis or its animations.

In one implementation, the listing of various possible mappings may be selected based on one or more other parameters, such as time of day, location as determined by the gps coordinates of the device, etc. Thus, for example, if an emoji for sun is selected in the evening, a different mapping of sun is provided vs in the afternoon. Similarly, if an emoji for a baseball is selected by a device that is in general vicinity of Denver, a list of mappings including Colorado Rockies hat may be displayed.

An operation 112 determines if a keyboard is dismissed, and if so, it keeps track of the chosen mask and the time of selecting the chosen mask. Tapping anywhere on the video will release the emoji keyboard, returning to the recording interface. Another determining operation 116 determines if a video interface is exited and if so, an operation 118 sends masks and time of placement to either burn the mask on the video or it is sent to a server. The video is sent to the server with an identifier of the mask (for example, Unicode may be used for the emoji, or a mapped id, or a special id if the emoji mask is a special mask or a user drawn mask) and the location, size, and rotation of the mask for each key frame (e.g. with a bounding box for each 1/32 of a second, and its coordinates of rotation). Note that multiple faces can be identified and saved to the server, including each with a different mask. For special masks, such as drawn masks or location specific masks (I love NY), or customized masks (tweaking the eyebrows on one for example), additional parameters may need to be passed to the server so it can recreate what the user saw. An alternative implementation has what the user saw burned into the video on the client device by recording the screen without the UI elements and then sending the new video. A combination of both techniques may also be used so that the original video is preserved.

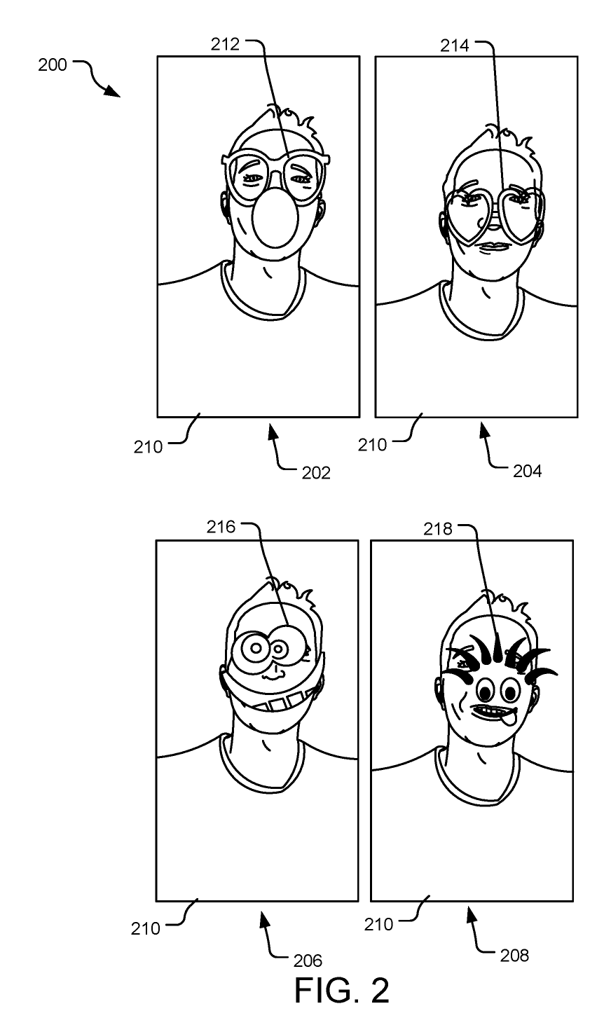

FIG. 2 illustrates various example still images 200 of emoji masks tracking a user face in a video. Specifically, each of still images 202-208 is illustrated to show a user 210 with masks 212-218, respectively, where such masks track the movement of the user 210. Some of the expression masks 212-218, such as the expression mask 218 may be a single emoji or expression selected from an emoji list and it is expanded or adjusted to the size of the face of the user 210 in the video. Alternatively, another of the masks, such as the mask 216, may be generated by combining more than one emoji or expression and expanding or adjusting the combined mask to the size of the face being tracked. Yet alternatively, the mask 214 may be developed using expression or may be a custom emoji designed by a user.

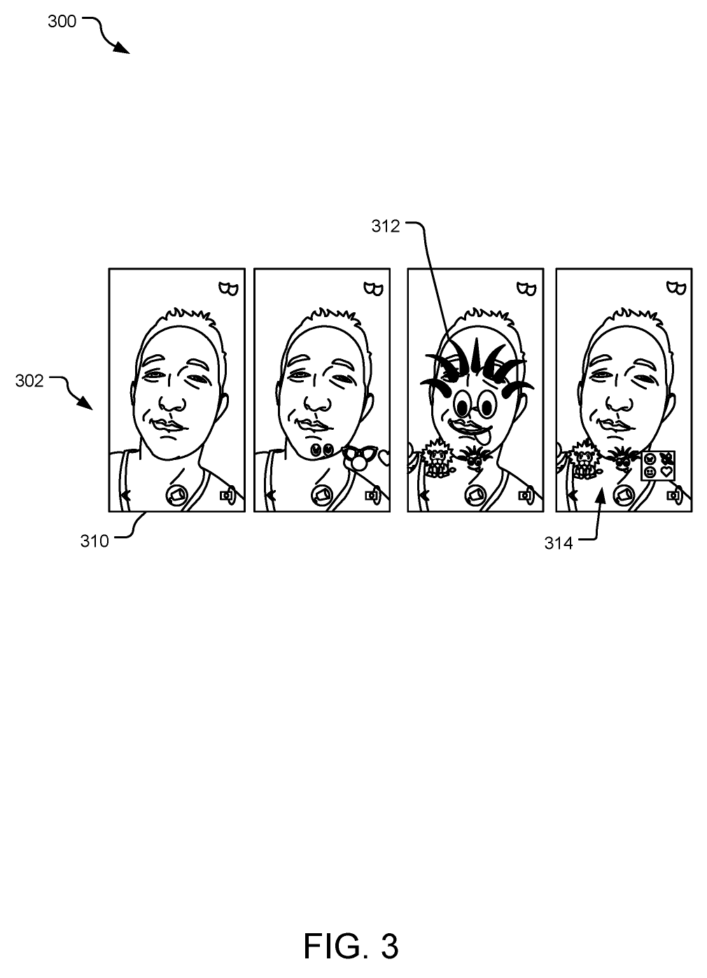

FIG. 3 illustrates an example interface for selecting an emoji to generate a mask. A user can start selecting an emoji mask for a video by using a toggle mask interface. When the user 310 has selected the toggle mask interface, a mask tray 314 appears at the bottom of the video screen. User can cycle through a selection of emojis in the mask tray 314 by scrolling from side to side. Once an emoji 312 is selected, the emoji begins to track the face of the user 310, maintaining an overlaid position while the user 310 moves.

In one implementation, the mask interface may be removed by a user tapping on the masks icon in a top right toggle, which toggles it on and off. Alternatively, the mask interface may be removed by pressing and holding anywhere in the center of the screen. In another implementation, a user can slide the emoji interface tray to the right (e.g. “throw the tray off the screen”) to remove the emoji interface. Furthermore, while the masks tray is active, a user can select other masks. However, the user may not be able to take one off and keep the tray there. Furthermore, the user may also switch masks before recording and/or during recording.

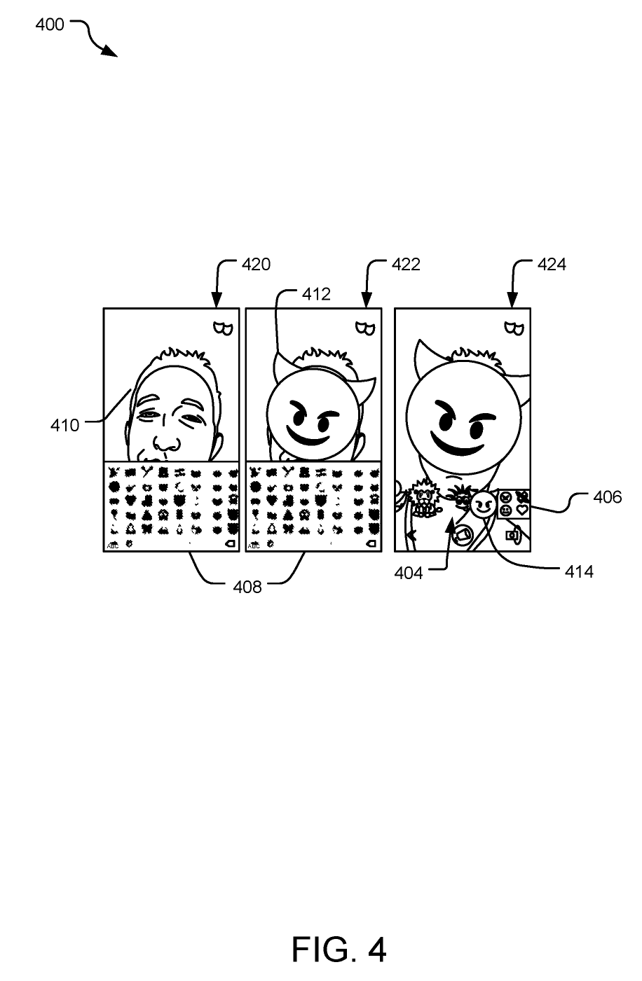

FIG. 4 illustrates example still images 400 demonstrating the use of an emoji keyboard for selecting an emoji to generate a mask. Once a user 410 selects a toggle mask interface, a tray 404 appears. As a user selects or cycles the tray, the item selected displays on the video and starts tracking the user's face. This can happen before recording, during recording, or after recording. At the far end of the mask tray 404 is an icon 406 indicating the emoji keyboard option. This can be selected by tapping on the icon 406, or in one implementation the keyboard will display automatically when the user scrolls the tray to the right. Once selected, the emoji keyboard 408 rises from the bottom of the screen, as seen in image 420, and the user 410 can select an emoji from those displayed on the keyboard which, once selected, begins to track the user's face. The selected emoji 412 also adapts its size so as to match the size of the user's face in the video. In image 422, the emoji 412 is transferred to the video at an initial size. In image 424 the emoji 412 has adapted its size in order to properly match the dimensions of the user's face and effectively mask it. Tapping on the video releases the keyboard, and the last emoji selected 414 takes a slot in the tray 404.

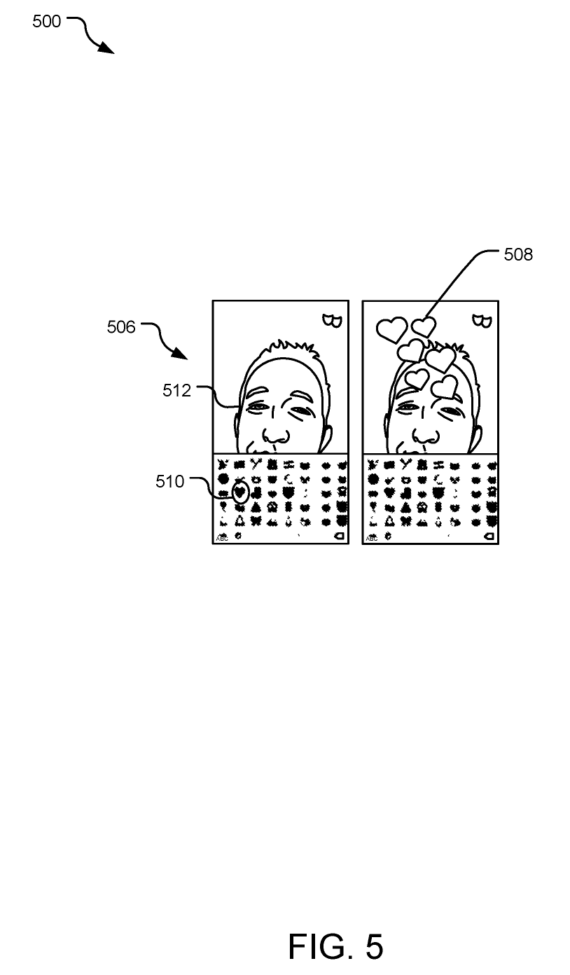

FIG. 5 illustrates the use of an “interpreted emoji”, where the emoji 510 isn't just blown up, but separate artwork, even animated artwork, can be displayed as a result of that emoji 510 being keyed in. When an “interpreted emoji” is associated with an animation, the system allows for the emoji to be used with a face offset that determines where to display the mask on the video. When emoji heart 510 is selected, the system tracks the location of the user's face and displays the animated hearts 508 above the head of the user 512 moving in the video.

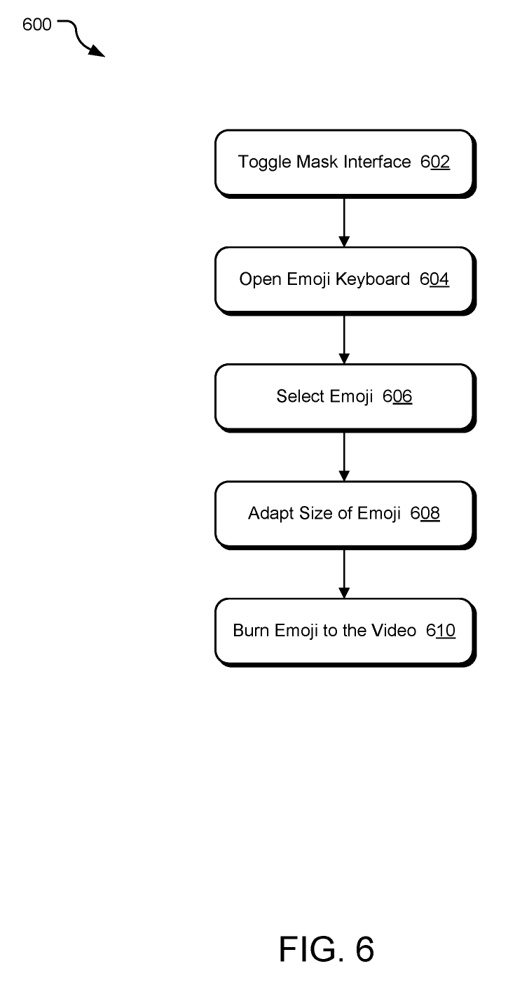

FIG. 6 illustrates a flow chart 600 detailing the process of a user recording a video with a face tracking emoji. An operation 602 presents a toggle mask interface, which in turn, causes a mask tray to appear at the bottom of the device screen. At operation 604 the user can select and open an emoji keyboard from the mask tray. User selects an icon indicating the emoji keyboard which will open a selective interface presenting an array of emoji icons. At operation 606, user selects an emoji icon from the array presented in the emoji keyboard. When the user selects an emoji, the emoji is displayed on top of the video, tracking the face of the user. Thus, for example, if an emoji of a moustache is placed on a face in the video, the moustache emoji may move in the video based on movement of the face. Such tracking of the emoji may be done based on analysis of the movement of a feature of the face. For example, the moustache emoji may be locked to the lips on the face in the video so that the movement of the lips also results in the movement of the emoji.

Furthermore, in an implementation, the user is given the capability to unlock the emoji from one feature and move to a different feature of an element in the video. For example, if a sunglass emoji were, by mistake, locked to the lips feature of a face, the user may be able to move it from the lips to the eyes, forehead, etc.

At operation 608, the selected emoji adapts its size in order to match the dimensions of the user's face. At operation 610, the mask can be burned to the video and saved, or can be sent to a server with an identifier of the mask (for example, Unicode may be used for the emoji, or a mapped id, or a special id if the emoji mask is a special mask or a user drawn mask) and the location, size, and rotation of the mask for each key frame.

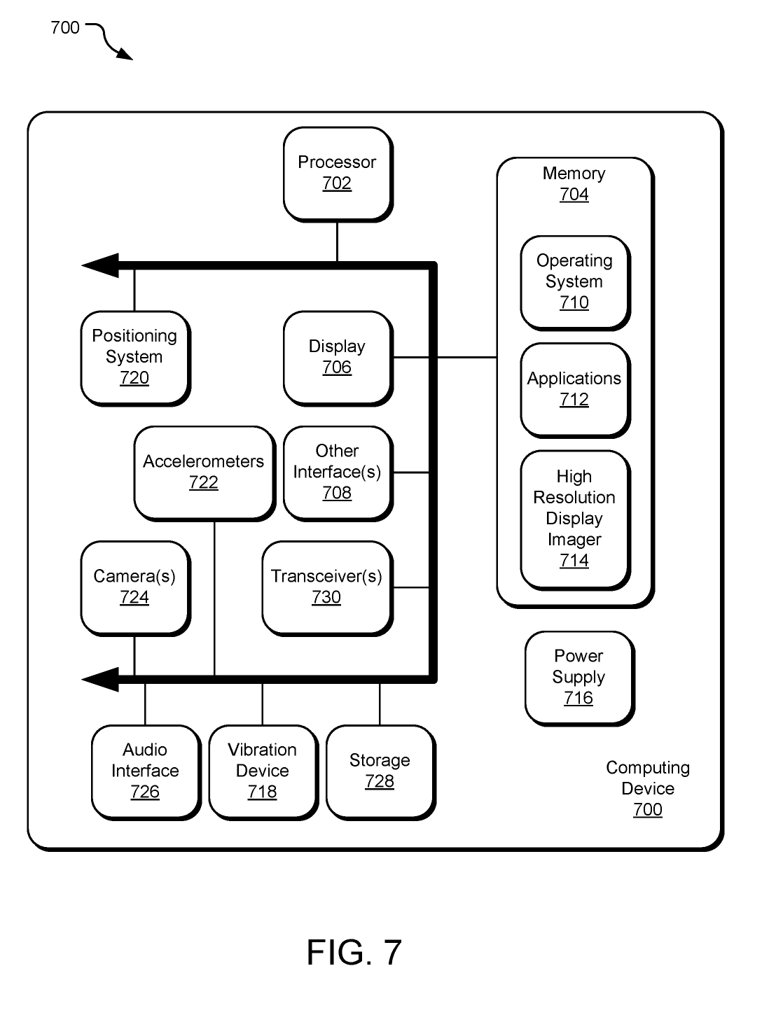

FIG. 7 illustrates an example system labeled as computing device 700 that may be useful in implementing the described technology. The example hardware and operating environment of FIG. 7 for implementing the described technology includes a computing device, such as a general purpose computing device in the form of a computer, a mobile telephone, a personal data assistant (PDA), a tablet, smart watch, gaming remote, or other type of computing device. It should be appreciated by those skilled in the art that any type of tangible computer-readable media may be used in the example operating environment. The computer may operate in a networked environment using logical connections to one or more remote computers, such as a remote computer. These logical connections are achieved by a communication device coupled to or a part of the computer; the implementations are not limited to a particular type of communications device. The remote computer may be another computer, a server, a router, a network PC, a client, a peer device or other common network node, and typically includes many or all of the elements described above relative to the computer.

The computing device 700 includes a processor 702, a memory 704, a display 706 (e.g., a touchscreen display), and other interfaces 708 (e.g., a keyboard). The memory 704 generally includes both volatile memory (e.g., RAM) and non-volatile memory (e.g., flash memory). An operating system 710 resides in the memory 704 and is executed by the processor 702, although it should be understood that other operating systems may be employed.

One or more application programs 712, such as a high resolution display imager 714, are loaded in the memory 704 and executed on the operating system 708 by the processor 702. The computing device 700 includes a power supply 716, which is powered by one or more batteries or other power sources and which provides power to other components of the computing device 700. The power supply 716 may also be connected to an external power source that overrides or recharges the built-in batteries or other power sources.

The computing device 700 includes one or more communication transceivers 730 to provide network connectivity (e.g., mobile phone network, Wi-Fi®, BlueTooth®, etc.). The computing device 700 also includes various other components, such as a positioning system 720 (e.g., a global positioning satellite transceiver), one or more accelerometers 722, one or more cameras 724, an audio interface 726 (e.g., a microphone, an audio amplifier and speaker and/or audio jack), a magnetometer (not shown), and additional storage 728. Other configurations may also be employed. The one or more communications transceivers 730 may be communicatively coupled to one or more antennas, including magnetic dipole antennas capacitively coupled to a parasitic resonating element. The one or more transceivers 730 may father be in communication with the operating system 710, such that data transmitted to or received from the operating system 710 may be sent or received by the communications transceivers 730 over the one or more antennas.

In an example implementation, a mobile operating system, wireless device drivers, various applications, and other modules and services may be embodied by instructions stored in memory 704 and/or storage devices 728 and processed by the processing unit 702. Device settings, service options, and other data may be stored in memory 704 and/or storage devices 728 as persistent datastores. In another example implementation, software or firmware instructions for generating carrier wave signals may be stored on the memory 704 and processed by processor 702. For example, the memory 704 may store instructions for tuning multiple inductively-coupled loops to impedance match a desired impedance at a desired frequency.

Mobile device 700 may include a variety of tangible computer-readable storage media and intangible computer-readable communication signals. Tangible computer-readable storage can be embodied by any available media that can be accessed by the computing device 700 and includes both volatile and nonvolatile storage media, removable and non-removable storage media. Tangible computer-readable storage media excludes intangible communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by computing device 700. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

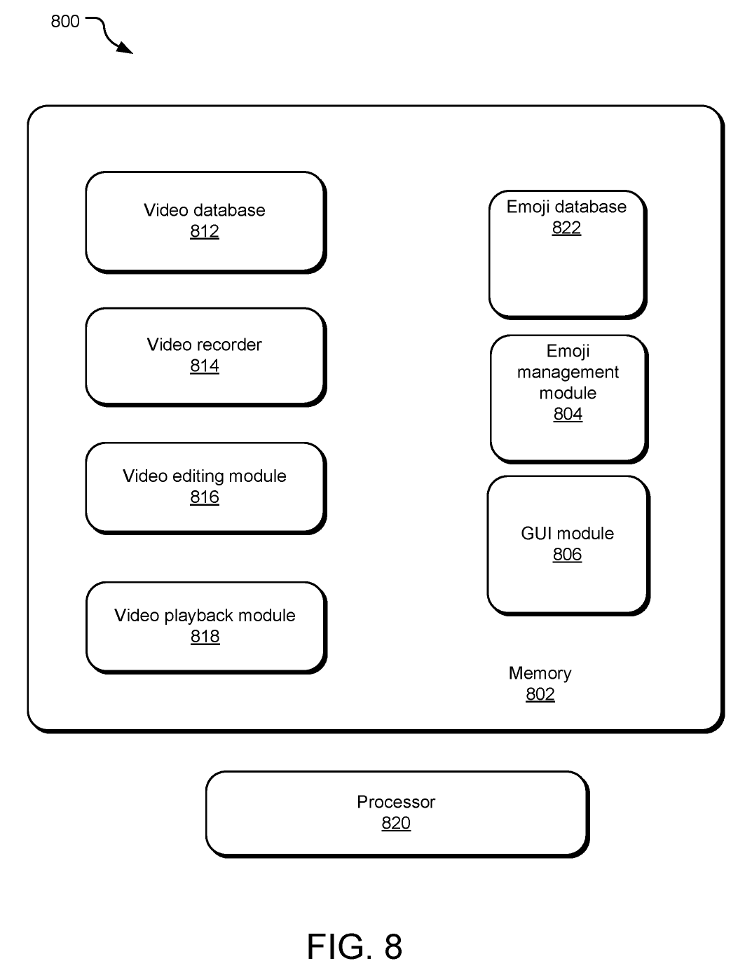

FIG. 8 illustrates an example expression management system 800 including various components of the described technology. Specifically, the expression management system 800 is implemented on a memory 802 with one or more modules and databases. The modules may include instructions that may be executed on a processor 820. An emoji management module 804 stores various instructions for performing functionalities disclosed herein. A GUI module 806 presents various user interfaces, such as the emoji keyboard, the emoji tray, etc., to a user on a user device based on the instructions from the emoji management module 804. The GUI module 806 may also be used to receive input from the user and communicate the input to the emoji management module 804 for further processing.

A video database 812 may be used to store videos. A video recorder 814 may be used to store instructions for recording videos using a video camera of a user device. A video editing module 816 may include instructions for editing the videos and a video playback module 818 allows a user to playback video. The emoji management module 804 may interact with one or more of the modules 812 to 818 to add emojis from an emoji database 822.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed is:

1. A method comprising:
receiving an input from a user during recording of a video;
in response to the input, presenting a plurality of expression graphics;
receiving a selection input from the user indicating selection of one of the plurality of expression graphics;
receiving a placement input indicating placement of the selected one of the plurality of expression graphics on the video; and
adding the selected one of the plurality of expression graphics in the video at a time indicated by the placement.

2. The method of claim 1, wherein the placement also provides the location of the one of the expression graphics on the video.

3. The method of claim 1, wherein the expression graphic is an emoji.

4. The method of claim 3, further comprising adjusting the size of the selected expression graphic to a size of an object identified in the video.

5. The method of claim 3, further comprising tracking the selected expression object to the object identified in the video.

6. The method of claim 5, further comprising tracking multiple expression objects to multiple objects identified in the video.

7. The method of claim 6, further comprising switching expression objects from one object to another object during recording in a group video.

8. The method of claim 1, wherein the expression object is animated.

9. The method of claim 1, wherein a user can create their own emoji by selecting a drawing icon.

10. The method of claim 1, wherein the emoji mask can be selected and added to the video prior to recording.

11. The method of claim 1, wherein the emoji mask can be selected and added to the video after recording.

12. A system for adding expression objects to a video, the system comprising:
a memory;
one or more processors; and
an expression management module including one or more computer instructions stored in the memory and executable by the one or more processors, the computer instructions comprising:
an instruction for presenting a plurality of expression graphics during recording of the video;
an instruction for receiving a selection input from the user indicating selection of one of the plurality of expression graphics;
an instruction for receiving a placement input indicating placement of the selected one of the plurality of expression graphics on the video; and
an instruction for adding the selected one of the plurality of expression graphics in the video at a time indicated by the placement.
